(19) United States
(12) Patent Application Publication
(10) Pub. No.: US 2024/0345299 A1
(43) Pub. Date: Oct. 17, 2024

(54) OPTICAL STRUCTURE

(71) Applicant: VisEra Technologies Company Limited, Hsin-Chu City (TW)

(72) Inventors: Cheng-Ta MU, Hsin-Chu City (TW); Po-Han FU, Hsin-Chu City (TW); Ming-Lun SHIH, Hsin-Chu City (TW); Sheng-Hui CHEN, Hsin-Chu City (TW); Liang-Ting WU, Hsin-Chu City (TW); Gui-Sheng ZENG, Hsin-Chu City (TW)

(21) Appl. No.: 18/299,708

(22) Filed: Apr. 12, 2023

(51) Int. Cl. G02B 5/28

(52) U.S. Cl. CPC G02B 5/288; G02B 5/281

(57) ABSTRACT

An optical structure is provided. The optical structure includes a substrate and multiple films disposed on the substrate. The multiple films include a first set of multiple films and a second set of multiple films. The first set of multiple films includes a plurality of first material layers and a plurality of second material layers including germanium oxide, germanium nitride or germanium hydroxide which are arranged in an alternating manner. The second set of multiple films includes a plurality of third material layers including germanium oxide, germanium nitride or germanium hydroxide and a plurality of fourth material layers which are arranged in an alternating manner. The thickness of the fourth material layer is greater than that of the first material layer.

### BACKGROUND OF THE INVENTION

### Field of the Invention

The invention relates to an optical structure, and more particularly to a high-contrast optical structure with multiple films.

### Description of the Related Art

Specialized devices can use near-infrared (NIR) spectroscopy to verify the identity of a user, to measure the attributes of a user (e.g., height and weight), to ascertain the characteristics of other subjects (e.g., the distance to an object, the size of an object, or the shape of an object), and other applications. However, during transmission of the NIR light towards the user, and once the light is reflected back from the user toward the optical receiver, ambient light may interfere with the NIR light, throwing off the accuracy of the aforementioned measurements.

### BRIEF SUMMARY OF THE INVENTION

In accordance with one embodiment of the invention, an optical structure is provided. The optical structure includes a substrate and multiple films disposed on the substrate. The multiple films include a first set of multiple films and a second set of multiple films disposed on the first set of multiple films. The first set of multiple films includes a plurality of first material layers with a first refractive index and a plurality of second material layers including germanium oxide, germanium nitride or germanium hydroxide with a second refractive index which are arranged in an alternating manner. The second refractive index is greater than the first refractive index. The second set of multiple films includes a plurality of third material layers including germanium oxide, germanium nitride or germanium hydroxide with a third refractive index and a plurality of fourth material layers with a fourth refractive index which are arranged in an alternating manner. The third refractive-index is greater than the fourth refractive index. The thickness of the fourth material layer is greater than that of the first material layer.

In some embodiments, the optical structure further includes a fifth material layer with a fifth refractive index disposed between the first set of multiple films and the second set of multiple films. The fifth refractive index is less than the second refractive index and the third refractive index.

In some embodiments, the first refractive index, the fourth refractive index and the fifth refractive index are in a range from 1.47 to 1.60 at a spectral range of 200 nm to 2200 nm. In some embodiments, the first material layer, the fourth material layer and the fifth material layer include silicon oxide (SiO₂), titanium oxide (TiO₂), niobium oxide (Nb₂O₅), tantalum oxide (Ta₂O₅), aluminum oxide (Al₂O₃) or silicon nitride (SiN).

In some embodiments, the second refractive index and the third refractive index are in a range from 3.98 to 4.42 at a spectral range of 200 nm to 2200 nm.

In some embodiments, the thickness of the first material layer is 1-2 times λ/4, and λ is the wavelength of the incident light. In some embodiments, the thickness of the second material layer is 0.2-0.5 times λ/4. In some embodiments, the thickness of the third material layer is 0.2-0.5 times λ/4. In some embodiments, the thickness of the second material layer is the same as that of the third material layer. In some embodiments, the thickness of the fourth material layer is 2-3 times λ/4. In some embodiments, the thickness of the fifth material layer is λ/4.

In some embodiments, in the first set of multiple films, there are 2 to 5 the first material layers alternating with 2 to 5 the second material layers. In some embodiments, in the second set of multiple films, there are 2 to 5 the third material layers alternating with 2 to 5 the fourth material layers.

In some embodiments, the multiple films are arranged in an (xL₁ y₁H₁)ₘ L₃ (y₂H₂ zL₂)ₙ order. In (xL₁ y₁H₁)ₘ representing the first set of multiple films, L₁ represents the first material layer, H₁ represents the second material layer, x represents the thickness of the first material layer, y₁ represents the thickness of the second material layer, and m is a quantity of alternating the first material layer and the second material layer. In (xL₁ y₁H₁)ₘ representing the first set of multiple films, x is 1-2 times λ/4, y₁ is 0.2-0.5 times λ/4, and m is an integer between 2 and 5. In (y₂H₂ zL₂)ₙ representing the second set of multiple films, H₂ represents the third material layer, L₂ represents the fourth material layer, y₂ represents the thickness of the third material layer, z represents the thickness of the fourth material layer, and n is a quantity of alternating the third material layer and the fourth material layer. In (y₂H₂ zL₂)ₙ representing the second set of multiple films, y₂ is 0.2-0.5 times λ/4, z is 2-3 times λ/4, and n is an integer between 2 and 5. L₃ represents the fifth material layer.

In some embodiments, the multiple films are arranged in an (1.15L₁ 0.25H₁)ₘ L₃ (0.25H₂ 2.2L₂)ₙ order. In (1.15L₁ 0.25H₁)ₘ representing the first set of multiple films, L₁ represents the first material layer, H₁ represents the second material layer, 1.15 represents the thickness of the first material layer and is 1.15 times λ/4, 0.25 represents the thickness of the second material layer and is 0.25 times λ/4, and m is a quantity of alternating the first material layer and the second material layer. In (1.15L₁ 0.25H₁)ₘ representing the first set of multiple films, m is an integer between 2 and 5. In (0.25H₂ 2.2L₂) n representing the second set of multiple films, H₂ represents the third material layer, L₂ represents the fourth material layer, 0.25 represents the thickness of the third material layer and is 0.25 times λ/4, 2.2 represents the thickness of the fourth material layer and is 2.2 times λ/4, and n is a quantity of alternating the third material layer and the fourth material layer. In (0.25H₂ 2.2L₂)ₙ representing the second set of multiple films, n is an integer between 2 and 5. L₃ represents the fifth material layer.

In some embodiments, the multiple films further include a sixth material layer with a sixth refractive index which is in a range from 1.20 to 4.46 or from 2.00 to 2.67 at a spectral range of 200 nm to 2200 nm. In some embodiments, the multiple films further include a seventh material layer with a seventh refractive index which is in a range from 1.47 to 1.51 or from 2.24 to 2.77 at a spectral range of 200 nm to 2200 nm.

In some embodiments, the total thickness of the multiple films is in a range from 4 μm to 5 μm. In some embodiments, the total number of layers of the multiple films is in a range from 17 to 25.

In some embodiments, the multiple films include a narrow-band pass filter that allows visible light, near-infrared light or far-infrared light to pass through. In some embodiments, the multiple films include a narrow-band pass filter that allows light with a wavelength of 1300 nm to 1600 nm to pass through.

In the present invention, the optical structure has the multiple films formed by the specific composition and configuration of the low-refractive-index material layers and the high-refractive-index material layers. For example, the multiple films of the optical structure include the first set of multiple films and the second set of multiple films. In the first set of multiple films, the first material layers (for example, silicon oxide (SiO₂)) and the second material layers (for example, germanium hydroxide) are arranged in an alternating manner. In the second set of multiple films, the third material layers (for example, germanium hydroxide) and the fourth material layers (for example, silicon oxide (SiO₂)) are arranged in an alternating manner. Specifically, the thickness of the fourth material layer in the second set of multiple films is greater than that of the first material layer in the first set of multiple films. In the present invention, the first set of multiple films and the second set of multiple films are designed for a long-pass filter and a low-pass filter respectively, which are combined to a narrow-band pass filter (NBPF). The narrow-band pass filter (NBPF) formed by the multiple films can be widely applied in, for example, visible (VIS) light, near-infrared (NIR) light and far-infrared (FIR) light.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows a cross-sectional view of an optical structure in accordance with one embodiment of the present invention;

FIG. 2 shows a cross-sectional view of an optical structure in accordance with one embodiment of the present invention;

FIG. 3 shows a cross-sectional view of an optical structure in accordance with one embodiment of the present invention;

FIG. 4 shows a cross-sectional view of multiple films of an optical structure in accordance with one embodiment of the present invention;

FIG. 5 shows a cross-sectional view of multiple films of an optical structure in accordance with one embodiment of the present invention;

FIG. 6 shows a relationship between the wavelength of the incident light and transmittance in an optical device in accordance with one embodiment of the present invention; and

FIG. 7 shows a relationship between the wavelength of the incident light and transmittance in an optical device in accordance with one embodiment of the present invention.

### DETAILED DESCRIPTION OF THE INVENTION

The optical device of the present invention is described in detail in the following description. In the following detailed description, for purposes of explanation, numerous specific details and embodiments are set forth in order to provide a thorough understanding of the present disclosure. The specific elements and configurations described in the following detailed description are set forth in order to clearly describe the present disclosure. It will be apparent, however, that the exemplary embodiments set forth herein are used merely for the purpose of illustration, and the inventive concept may be embodied in various forms without being limited to those exemplary embodiments. In addition, the drawings of different embodiments may use like and/or corresponding numerals to denote like and/or corresponding elements in order to clearly describe the present disclosure. However, the use of like and/or corresponding numerals in the drawings of different embodiments does not suggest any correlation between different embodiments. In addition, in this specification, expressions such as “first material layer disposed on/over a second material layer”, may indicate the direct contact of the first material layer and the second material layer, or it may indicate a non-contact state with one or more intermediate layers between the first material layer and the second material layer. In the above situation, the first material layer may not be in direct contact with the second material layer.

In addition, in this specification, relative expressions are used. For example, “lower”, “bottom”, “higher” or “top” are used to describe the position of one element relative to another. It should be appreciated that if a device is flipped upside down, an element that is “lower” will become an element that is “higher”.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In the description, relative terms such as “lower”, “upper”, “horizontal”, “vertical”, “above”, “below”, “up”, “down”, “top” and “bottom” as well as derivative thereof (e.g., “horizontally”, “downwardly”, “upwardly”, etc.) should be construed as referring to the orientation as described or as shown in the drawing under discussion. These relative terms are for convenience of description and do not require that the apparatus be constructed or operated in a particular orientation. Terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

It should be understood that, although the terms first, second, third etc. may be used herein to describe various elements, components, regions, layers, portions and/or sections, these elements, components, regions, layers, portions and/or sections should not be limited by these terms. These terms are only used to distinguish one element, component, region, layer, portion or section from another element, component, region, layer or section. Thus, a first element, component, region, layer, portion or section discussed below could be termed a second element, component, region, layer, portion or section without departing from the teachings of the present disclosure.

Herein, the terms “about”, “around” and “substantially” typically mean +/−20% of the stated value or range, typically +/−10% of the stated value or range, typically +/−5% of the stated value or range, typically +/−3% of the stated value or range, typically +/−2% of the stated value or range, typically +/−1% of the stated value or range, and typically +/−0.5% of the stated value or range. The stated value of the present disclosure is an approximate value. Namely, the meaning of “about”, “around” and “substantially” may be implied if there is no specific description of “about”, “around” and “substantially”.

The following description is of the best-contemplated mode of carrying out the invention. This description is made for the purpose of illustrating the general principles of the invention and should not be taken in a limiting sense. The scope of the invention is best determined by reference to the appended claims.

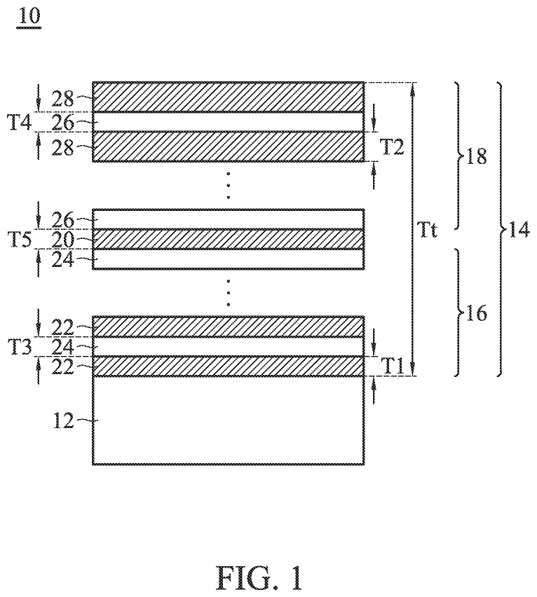

Referring to FIG. 1, in accordance with one embodiment of the present invention, an optical structure 10 is provided. FIG. 1 shows a cross-sectional view of the optical structure 10.

As shown in FIG. 1, the optical structure 10 of the present invention includes a substrate 12 and multiple films 14. The multiple films 14 are disposed on the substrate 12. The multiple films 14 include a first set of multiple films 16 and a second set of multiple films 18. The second set of multiple films 18 is disposed on the first set of multiple films 16. The first set of multiple films 16 includes a plurality of first material layers 22 with a first refractive index and a plurality of second material layers 24 with a second refractive index which are arranged in an alternating manner. The second refractive index is greater than the first refractive index. The second material layers 24 include germanium oxide, germanium nitride or germanium hydroxide. The second set of multiple films 18 includes a plurality of third material layers 26 with a third refractive index and a plurality of fourth material layers 28 with a fourth refractive index which are arranged in an alternating manner. The third refractive-index is greater than the fourth refractive index. The third material layers 26 include germanium oxide, germanium nitride or germanium hydroxide. Specifically, the thickness T2 of the fourth material layer 28 in the second set of multiple films 18 is greater than the thickness T1 of the first material layer 22 in the first set of multiple films 16.

In some embodiments, the substrate 12 may include a rigid substrate or a flexible substrate, for example, a glass substrate or a polyimide (PI) substrate.

In some embodiments, the optical structure 10 further includes a fifth material layer 20 with a fifth refractive index disposed between the first set of multiple films 16 and the second set of multiple films 18. The fifth refractive index is less than the second refractive index and the third refractive index.

In some embodiments, the first refractive index, the fourth refractive index and the fifth refractive index are in a range from 1.47 to 1.60 at a spectral range of 200 nm to 2200 nm. In some embodiments, the first material layer 22, the fourth material layer 28 and the fifth material layer 20 may include silicon oxide (SiO₂), titanium oxide (TiO₂), niobium oxide (Nb₂O₅), tantalum oxide (Ta₂O₅), aluminum oxide (Al₂O₃) or silicon nitride (SiN).

In some embodiments, the second refractive index and the third refractive index are in a range from 3.98 to 4.42 at a spectral range of 200 nm to 2200 nm. In some embodiments, the second material layer 24 and the third material layer 26 may include, for example, GeO₂H₁₀. In some embodiments, GeO₂H₁₀ has a higher refractive index (n=4.1-4.2) and a lower extinction coefficient (k=0.006-0.01) than other germanium hydroxides at specific wavelengths, for example, 1350 and 1550, and is quite suitable as a high-refractive-index material in the present invention.

In some embodiments, the thickness T1 of the first material layer 22 is about 1-2 times λ/4, and “A” is the wavelength of the incident light. In some embodiments, the thickness T3 of the second material layer 24 is about 0.2-0.5 times λ/4. In some embodiments, the thickness T4 of the third material layer 26 is about 0.2-0.5 times λ/4. In some embodiments, the thickness T3 of the second material layer 24 is different from the thickness T4 of the third material layer 26. In some embodiments, the thickness T3 of the second material layer 24 is the same as the thickness T4 of the third material layer 26. In some embodiments, the thickness T2 of the fourth material layer 28 is about 2-3 times λ/4. In some embodiments, the thickness T5 of the fifth material layer 20 is about λ/4.

In some embodiments, in the first set of multiple films 16, there are 2 to 5 the first material layers 22 alternating with 2 to 5 the second material layers 24. In some embodiments, in the second set of multiple films 18, there are 2 to 5 the third material layers 26 alternating with 2 to 5 the fourth material layers 28.

In some embodiments, the total thickness Tt of the multiple films 14 is in a range from about 4 μm to about 5 μm. In some embodiments, the total number of layers of the multiple films 14 is in a range from about 17 to about 25.

In some embodiments, the multiple films 14 include a narrow-band pass filter (NBPF) that allows visible (VIS) light, near-infrared (NIR) light or far-infrared (FIR) light to pass through. In some embodiments, the multiple films 14 include a narrow-band pass filter that allows light with a wavelength of about 1300 nm to about 1600 nm to pass through.

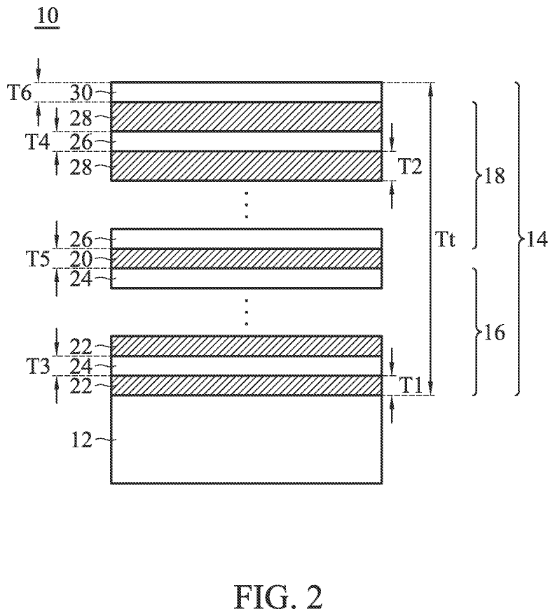

Referring to FIG. 2, in accordance with one embodiment of the present invention, an optical structure 10 is provided. FIG. 2 shows a cross-sectional view of the optical structure 10.

As shown in FIG. 2, the optical structure 10 of the present invention includes a substrate 12 and multiple films 14. The multiple films 14 are disposed on the substrate 12. The multiple films 14 include a first set of multiple films 16 and a second set of multiple films 18. The second set of multiple films 18 is disposed on the first set of multiple films 16. The first set of multiple films 16 includes a plurality of first material layers 22 with a first refractive index and a plurality of second material layers 24 with a second refractive index which are arranged in an alternating manner. The second refractive index is greater than the first refractive index. The second material layers 24 include germanium oxide, germanium nitride or germanium hydroxide. The second set of multiple films 18 includes a plurality of third material layers 26 with a third refractive index and a plurality of fourth material layers 28 with a fourth refractive index which are arranged in an alternating manner. The third refractive-index is greater than the fourth refractive index. The third material layers 26 include germanium oxide, germanium nitride or germanium hydroxide. Specifically, the thickness T2 of the fourth material layer 28 in the second set of multiple films 18 is greater than the thickness T1 of the first material layer 22 in the first set of multiple films 16.

In some embodiments, the substrate 12 may include a rigid substrate or a flexible substrate, for example, a glass substrate or a polyimide (PI) substrate.

In some embodiments, the optical structure 10 further includes a fifth material layer 20 with a fifth refractive index disposed between the first set of multiple films 16 and the second set of multiple films 18. The fifth refractive index is less than the second refractive index and the third refractive index.

In some embodiments, the multiple films 14 further includes a sixth material layer 30 with a sixth refractive index disposed on the second set of multiple films 18, but the present invention is not limited thereto. In some embodiments, the sixth material layer 30 is disposed between the substrate 12 and the first set of multiple films 16. In some embodiments, the sixth material layer 30 is inserted in the first set of multiple films 16. In some embodiments, the sixth material layer 30 is disposed between the first set of multiple films 16 and the fifth material layer 20. In some embodiments, the sixth material layer 30 is disposed between the fifth material layer 20 and the second set of multiple films 18. In some embodiments, the sixth material layer 30 is inserted in the second set of multiple films 18. In some embodiments, the sixth refractive index is in a range from 1.20 to 4.46 or from 2.00 to 2.67 at a spectral range of 200 nm to 2200 nm.

In some embodiments, the first refractive index, the fourth refractive index and the fifth refractive index are in a range from 1.47 to 1.60 at a spectral range of 200 nm to 2200 nm. In some embodiments, the first material layer 22, the fourth material layer 28 and the fifth material layer 20 may include silicon oxide (SiO₂), titanium oxide (TiO₂), niobium oxide (Nb₂O₅), tantalum oxide (Ta₂O₅), aluminum oxide (Al₂O₃) or silicon nitride (SiN).

In some embodiments, the second refractive index and the third refractive index are in a range from 3.98 to 4.42 at a spectral range of 200 nm to 2200 nm. In some embodiments, the second material layer 24 and the third material layer 26 may include, for example, GeO₂H₁₀.

In some embodiments, the thickness T1 of the first material layer 22 is about 1-2 times λ/4, and “λ” is the wavelength of the incident light. In some embodiments, the thickness T3 of the second material layer 24 is about 0.2-0.5 times λ/4. In some embodiments, the thickness T4 of the third material layer 26 is about 0.2-0.5 times λ/4. In some embodiments, the thickness T3 of the second material layer 24 is different from the thickness T4 of the third material layer 26. In some embodiments, the thickness T3 of the second material layer 24 is the same as the thickness T4 of the third material layer 26. In some embodiments, the thickness T2 of the fourth material layer 28 is about 2-3 times λ/4. In some embodiments, the thickness T5 of the fifth material layer 20 is about λ/4. In some embodiments, the thickness T6 of the sixth material layer 30 is about λ/4.

In some embodiments, in the first set of multiple films 16, there are 2 to 5 the first material layers 22 alternating with 2 to 5 the second material layers 24. In some embodiments, in the second set of multiple films 18, there are 2 to 5 the third material layers 26 alternating with 2 to 5 the fourth material layers 28.

In some embodiments, the total thickness Tt of the multiple films 14 is in a range from about 4 μm to about 5 μm. In some embodiments, the total number of layers of the multiple films 14 is in a range from about 17 to about 25.

In some embodiments, the multiple films 14 include a narrow-band pass filter (NBPF) that allows visible (VIS) light, near-infrared (NIR) light or far-infrared (FIR) light to pass through. In some embodiments, the multiple films 14 include a narrow-band pass filter that allows light with a wavelength of about 1300 nm to about 1600 nm to pass through.

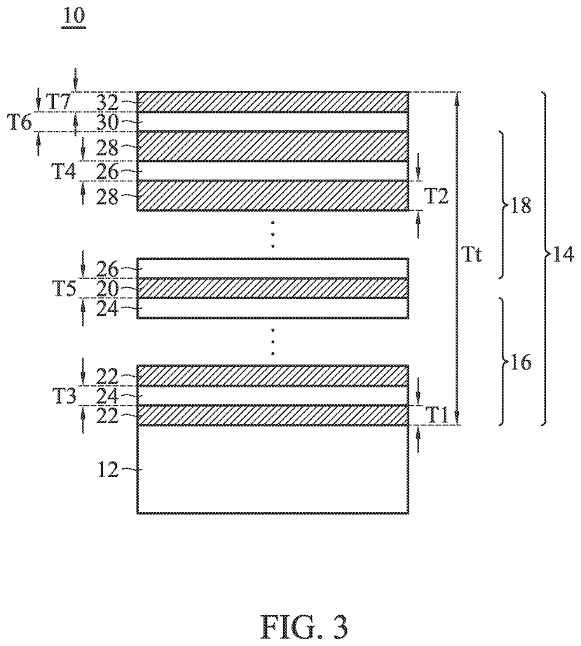

Referring to FIG. 3, in accordance with one embodiment of the present invention, an optical structure 10 is provided. FIG. 3 shows a cross-sectional view of the optical structure 10.

As shown in FIG. 3, the optical structure 10 of the present invention includes a substrate 12 and multiple films 14. The multiple films 14 are disposed on the substrate 12. The multiple films 14 include a first set of multiple films 16 and a second set of multiple films 18. The second set of multiple films 18 is disposed on the first set of multiple films 16. The first set of multiple films 16 includes a plurality of first material layers 22 with a first refractive index and a plurality of second material layers 24 with a second refractive index which are arranged in an alternating manner. The second refractive index is greater than the first refractive index. The second material layers 24 include germanium oxide, germanium nitride or germanium hydroxide. The second set of multiple films 18 includes a plurality of third material layers 26 with a third refractive index and a plurality of fourth material layers 28 with a fourth refractive index which are arranged in an alternating manner. The third refractive-index is greater than the fourth refractive index. The third material layers 26 include germanium oxide, germanium nitride or germanium hydroxide. Specifically, the thickness T2 of the fourth material layer 28 in the second set of multiple films 18 is greater than the thickness T1 of the first material layer 22 in the first set of multiple films 16.

In some embodiments, the substrate 12 may include a rigid substrate or a flexible substrate, for example, a glass substrate or a polyimide (PI) substrate.

In some embodiments, the optical structure 10 further includes a fifth material layer 20 with a fifth refractive index disposed between the first set of multiple films 16 and the second set of multiple films 18. The fifth refractive index is less than the second refractive index and the third refractive index.

In some embodiments, the multiple films 14 further includes a sixth material layer 30 with a sixth refractive index disposed on the second set of multiple films 18, but the present invention is not limited thereto. In some embodiments, the sixth material layer 30 is disposed between the substrate 12 and the first set of multiple films 16. In some embodiments, the sixth material layer 30 is inserted in the first set of multiple films 16. In some embodiments, the sixth material layer 30 is disposed between the first set of multiple films 16 and the fifth material layer 20. In some embodiments, the sixth material layer 30 is disposed between the fifth material layer 20 and the second set of multiple films 18. In some embodiments, the sixth material layer 30 is inserted in the second set of multiple films 18. In some embodiments, the sixth refractive index is in a range from 1.20 to 4.46 or from 2.00 to 2.67 at a spectral range of 200 nm to 2200 nm.

In some embodiments, the multiple films 14 further includes a seventh material layer 32 with a seventh refractive index disposed on the sixth material layer 30, but the present invention is not limited thereto. In some embodiments, the seventh material layer 32 is disposed between the substrate 12 and the first set of multiple films 16. In some embodiments, the seventh material layer 32 is inserted in the first set of multiple films 16. In some embodiments, the seventh material layer 32 is disposed between the first set of multiple films 16 and the fifth material layer 20. In some embodiments, the seventh material layer 32 is disposed between the fifth material layer 20 and the second set of multiple films 18. In some embodiments, the seventh material layer 32 is inserted in the second set of multiple films 18. In some embodiments, the seventh refractive index is in a range from 1.47 to 1.51 or from 2.24 to 2.77 at a spectral range of 200 nm to 2200 nm.

In some embodiments, the first refractive index, the fourth refractive index and the fifth refractive index are in a range from 1.47 to 1.60 at a spectral range of 200 nm to 2200 nm. In some embodiments, the first material layer 22, the fourth material layer 28 and the fifth material layer 20 may include silicon oxide (SiO₂), titanium oxide (TiO₂), niobium oxide (Nb₂O₅), tantalum oxide (Ta₂O₅), aluminum oxide (Al₂O₃) or silicon nitride (SiN).

In some embodiments, the second refractive index and the third refractive index are in a range from 3.98 to 4.42 at a spectral range of 200 nm to 2200 nm. In some embodiments, the second material layer 24 and the third material layer 26 may include, for example, GeO₂H₁₀.

In some embodiments, the thickness T1 of the first material layer 22 is about 1-2 times λ/4, and “A” is the wavelength of the incident light. In some embodiments, the thickness T3 of the second material layer 24 is about 0.2-0.5 times λ/4. In some embodiments, the thickness T4 of the third material layer 26 is about 0.2-0.5 times λ/4. In some embodiments, the thickness T3 of the second material layer 24 is different from the thickness T4 of the third material layer 26. In some embodiments, the thickness T3 of the second material layer 24 is the same as the thickness T4 of the third material layer 26. In some embodiments, the thickness T2 of the fourth material layer 28 is about 2-3 times λ/4. In some embodiments, the thickness T5 of the fifth material layer 20 is about λ/4. In some embodiments, the thickness T6 of the sixth material layer 30 is about λ/4. In some embodiments, the thickness T7 of the seventh material layer 32 is about λ/4.

In some embodiments, in the first set of multiple films 16, there are 2 to 5 the first material layers 22 alternating with 2 to 5 the second material layers 24. In some embodiments, in the second set of multiple films 18, there are 2 to 5 the third material layers 26 alternating with 2 to 5 the fourth material layers 28.

In some embodiments, the total thickness Tt of the multiple films 14 is in a range from about 4 μm to about 5 μm. In some embodiments, the total number of layers of the multiple films 14 is in a range from about 17 to about 25.

In some embodiments, the multiple films 14 include a narrow-band pass filter (NBPF) that allows visible (VIS) light, near-infrared (NIR) light or far-infrared (FIR) light to pass through. In some embodiments, the multiple films 14 include a narrow-band pass filter that allows light with a wavelength of about 1300 nm to about 1600 nm to pass through.

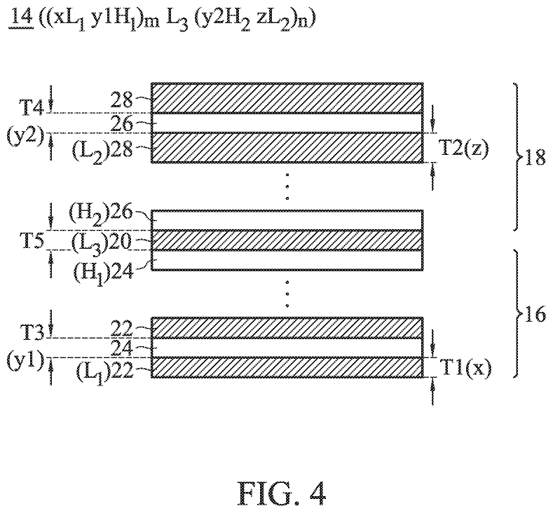

Referring to FIG. 4, in accordance with one embodiment of the present invention, partial structure (i.e. the multiple films 14) of the optical structure 10 as shown in FIG. 1 is provided. FIG. 4 shows a cross-sectional view of the multiple films 14 of the optical structure 10.

As shown in FIG. 4, the multiple films 14 of the present invention are arranged in an (xL₁ y₁H₁)ₘ L₃ (y₂H₂ zL₂)ₙ order. In (xL₁ y₁H₁)ₘ representing the first set of multiple films 16, L₁ represents the first material layer 22, H₁ represents the second material layer 24, x represents the thickness T1 of the first material layer 22, y₁ represents the thickness T3 of the second material layer 24, and m is a quantity of alternating the first material layer 22 and the second material layer 24. In (xL₁ y₁H₁)ₘ representing the first set of multiple films 16, x is 1-2 times λ/4 (λ: the wavelength of the incident light), y₁ is 0.2-0.5 times λ/4, and m is an integer between 2 and 5. In (y₂H₂ zL₂) n representing the second set of multiple films 18, H₂ represents the third material layer 26, L₂ represents the fourth material layer 28, y₂ represents the thickness T4 of the third material layer 26, z represents the thickness T2 of the fourth material layer 28, and n is a quantity of alternating the third material layer 26 and the fourth material layer 28. In (y₂H₂ zL₂), representing the second set of multiple films 18, y₂ is 0.2-0.5 times λ/4, z is 2-3 times λ/4, n is an integer between 2 and 5. In addition, L₃ represents the fifth material layer 20. In some embodiments, the thickness T5 of the fifth material layer 20 is about λ/4.

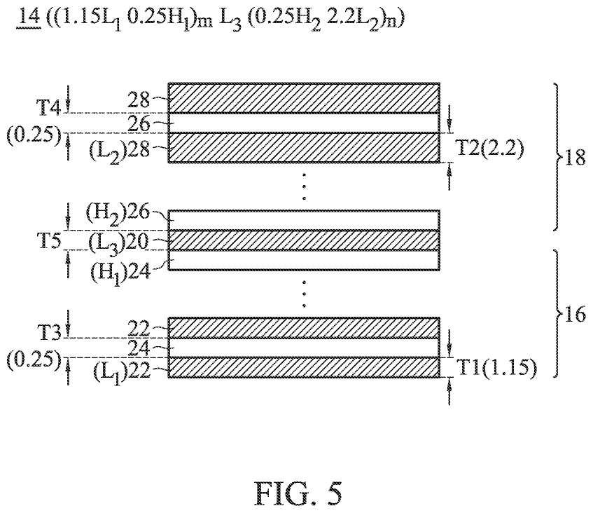

Referring to FIG. 5, in accordance with one embodiment of the present invention, partial structure (i.e. the multiple films 14) of the optical structure 10 as shown in FIG. 1 is provided. FIG. 5 shows a cross-sectional view of the multiple films 14 of the optical structure 10.

As shown in FIG. 5, the multiple films 14 of the present invention are arranged in an (1.15L₁ 0.25H₁)ₘ L₃ (0.25H₂ 2.2L₂), order. In (1.15L₁ 0.25H₁)ₘ representing the first set of multiple films 16, L₁ represents the first material layer 22, H₁ represents the second material layer 24, 1.15 represents the thickness T1 of the first material layer 22 and is 1.15 times λ/4 (λ: the wavelength of the incident light), 0.25 represents the thickness T3 of the second material layer 24 and is 0.25 times λ/4, and m is a quantity of alternating the first material layer 22 and the second material layer 24. In (1.15L₁ 0.25H₁)ₘ representing the first set of multiple films 16, m is an integer between 2 and 5. In (0.25H₂ 2.2L₂) n representing the second set of multiple films 18, H₂ represents the third material layer 26, L₂ represents the fourth material layer 28, 0.25 represents the thickness T4 of the third material layer 26 and is 0.25 times λ/4, 2.2 represents the thickness T2 of the fourth material layer 28 and is 2.2 times λ/4, and n is a quantity of alternating the third material layer 26 and the fourth material layer 28. In (0.25H₂ 2.2L₂), representing the second set of multiple films 18, n is an integer between 2 and 5. In addition, L₃ represents the fifth material layer 20. In some embodiments, the thickness T5 of the fifth material layer 20 is about λ/4.

### EXAMPLES

### Example 1

The Relationship Between the Wavelength of Incident Light and Transmittance in the Optical Device I

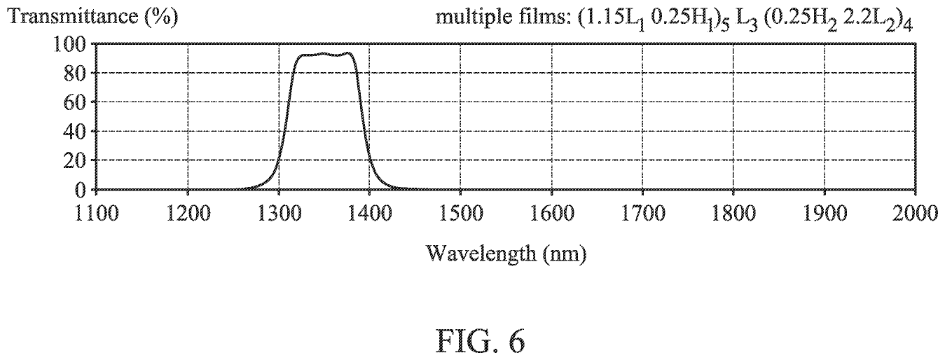

In the example, the optical device I includes the optical structure 10 as shown in FIG. 3. The substrate 12 is a glass substrate. The multiple films 14 are arranged in an (1.15L₁ 0.25H₁)₅ L₃ (0.25H₂ 2.2L₂)₄ order and the two additional material layers 30 and 32 are added therein. In (1.15L₁ 0.25H₁)₅ representing the first set of multiple films 16, L₁ represents the first material layer 22, H₁ represents the second material layer 24, 1.15 represents the thickness of the first material layer 22 and is 1.15 times λ/4 (λ: the wavelength of the incident light), and 0.25 represents the thickness of the second material layer 24 and is 0.25 times λ/4. The first material layers 22 and the second material layers 24 are arranged in an alternating manner, and 5 is the quantity of alternating the first material layer 22 and the second material layer 24. In (0.25H₂ 2.2L₂)₄ representing the second set of multiple films 18, H₂ represents the third material layer 26, L₂ represents the fourth material layer 28, 0.25 represents the thickness of the third material layer 26 and is 0.25 times λ/4, and 2.2 represents the thickness of the fourth material layer 28 and is 2.2 times λ/4. The third material layers 26 and the fourth material layers 28 are arranged in an alternating manner, and 4 is the quantity of alternating the third material layer 26 and the fourth material layer 28. In addition, L₃ represents the fifth material layer 20. The material of the first material layer 22, the fourth material layer 28 and the fifth material layer 20 is silicon oxide (SiO₂). The material of the second material layer 24 and the third material layer 26 is germanium hydroxide (GeO₂H₁₀). The total number of layers of the multiple films 14 is 21. The material and thickness of each element and layer in the optical device I are listed in Table 1. The experiment is performed on the optical device I to obtain the relationship between wavelength (nm) of incident light and transmittance (%), and the results are shown in FIG. 6.

TABLE 1

| Layer | Material | Thickness (nm) |
|---|---|---|
| 21 | SiO₂ | 580.08 |
| 20 | GeO₂H₁₀ | 35.12 |
| 19 | SiO₂ | 10.11 |
| 18 | GeO₂H₁₀ | 11.29 |
| 17 | SiO₂ | 507.9 |
| 16 | GeO₂H₁₀ | 33.83 |
| 15 | SiO₂ | 347.31 |
| 14 | GeO₂H₁₀ | 70.05 |
| 13 | SiO₂ | 369.63 |
| 12 | GeO₂H₁₀ | 11.95 |
| 11 | SiO₂ | 10.04 |
| 10 | GeO₂H₁₀ | 10.06 |
| 9 | SiO₂ | 494.83 |
| 8 | GeO₂H₁₀ | 68.71 |
| 7 | SiO₂ | 305.78 |
| 6 | GeO₂H₁₀ | 64.65 |
| 5 | SiO₂ | 466.88 |
| 4 | GeO₂H₁₀ | 10.78 |
| 3 | SiO₂ | 464.17 |
| 2 | GeO₂H₁₀ | 58.21 |
| 1 | SiO₂ | 206.42 |
| Substrate | Glass | |

| | |
|---|---|
| Total thickness | 4137.8 |

In accordance with FIG. 6, when the wavelength of the incident light is in a range from 1100 nm to 1250 nm, the transmittance is lower than 1%. When the wavelength of the incident light is in a range from 1325 nm to 1375 nm, the transmittance is higher than 91%. When the wavelength of the incident light is in a range from 1450 nm to 2000 nm, the transmittance is lower than 1%. Therefore, the optical device I of the present invention has a high transmittance for a specific wavelength (ex. 1300 nm to 1400 nm) of incident light, which meets the design requirements of NBPF.

### Example 2

The Relationship Between the Wavelength of Incident Light and Transmittance in the Optical Device II

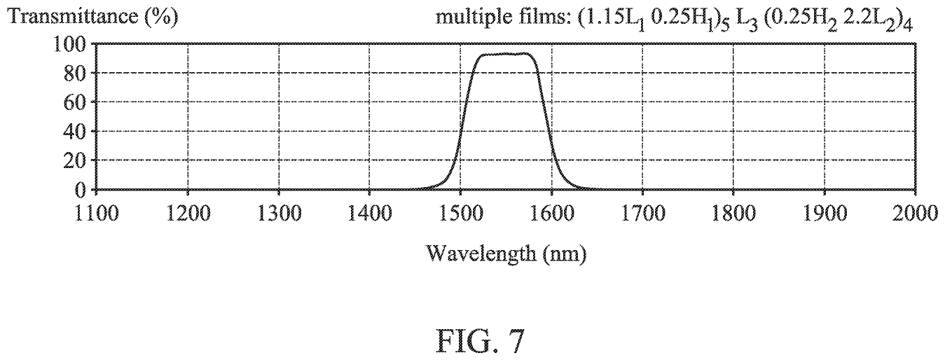

In the example, the optical device II includes the optical structure 10 as shown in FIG. 3. The substrate 12 is a glass substrate. The multiple films 14 are arranged in an (1.15L₁ 0.25H₁)₅ L₃ (0.25H₂ 2.2L₂)₄ order and the two additional material layers 30 and 32 are added therein. In (1.15L₁ 0.25H₁)₅ representing the first set of multiple films 16, L₁ represents the first material layer 22, H₁ represents the second material layer 24, 1.15 represents the thickness of the first material layer 22 and is 1.15 times λ/4 (λ: the wavelength of the incident light), and 0.25 represents the thickness of the second material layer 24 and is 0.25 times λ/4. The first material layers 22 and the second material layers 24 are arranged in an alternating manner, and 5 is the quantity of alternating the first material layer 22 and the second material layer 24. In (0.25H₂ 2.2L₂)₄ representing the second set of multiple films 18, H₂ represents the third material layer 26, L₂ represents the fourth material layer 28, 0.25 represents the thickness of the third material layer 26 and is 0.25 times λ/4, and 2.2 represents the thickness of the fourth material layer 28 and is 2.2 times λ/4. The third material layers 26 and the fourth material layers 28 are arranged in an alternating manner, and 4 is the quantity of alternating the third material layer 26 and the fourth material layer 28. In addition, L₃ represents the fifth material layer 20. The material of the first material layer 22, the fourth material layer 28 and the fifth material layer 20 is silicon oxide (SiO₂). The material of the second material layer 24 and the third material layer 26 is germanium hydroxide (GeO₂H₁₀). The total number of layers of the multiple films 14 is 21. The material and thickness of each element and layer in the optical device II are listed in Table 2. The experiment is performed on the optical device II to obtain the relationship between wavelength (nm) of incident light and transmittance (%), and the results are shown in FIG. 7.

TABLE 2

| Layer | Material | Thickness (nm) |
|---|---|---|
| 21 | SiO₂ | 650.27 |
| 20 | GeO₂H₁₀ | 10.22 |
| 19 | SiO₂ | 10.63 |
| 18 | GeO₂H₁₀ | 51.03 |
| 17 | SiO₂ | 543.55 |
| 16 | GeO₂H₁₀ | 59.29 |
| 15 | SiO₂ | 467.75 |
| 14 | GeO₂H₁₀ | 81.71 |
| 13 | SiO₂ | 304.39 |
| 12 | GeO₂H₁₀ | 42.58 |
| 11 | SiO₂ | 10 |
| 10 | GeO₂H₁₀ | 10 |
| 9 | SiO₂ | 562.09 |
| 8 | GeO₂H₁₀ | 88.99 |
| 7 | SiO₂ | 263.82 |
| 6 | GeO₂H₁₀ | 90.58 |
| 5 | SiO₂ | 538.34 |
| 4 | GeO₂H₁₀ | 10 |
| 3 | SiO₂ | 540 |
| 2 | GeO₂H₁₀ | 62.01 |
| 1 | SiO₂ | 11.51 |
| Substrate | Glass | |

| | |
|---|---|
| Total thickness | 4408.75 |

In accordance with FIG. 7, when the wavelength of the incident light is in a range from 1100 nm to 1450 nm, the transmittance is lower than 1%. When the wavelength of the incident light is in a range from 1525 nm to 1575 nm, the transmittance is higher than 93%. When the wavelength of the incident light is in a range from 1650 nm to 2000 nm, the transmittance is lower than 1%. Therefore, the optical device II of the present invention has a high transmittance for a specific wavelength (ex. 1500 nm to 1600 nm) of incident light, which meets the design requirements of NBPF.

In the present invention, the optical structure has the multiple films formed by the specific composition and configuration of the low-refractive-index material layers and the high-refractive-index material layers. For example, the multiple films of the optical structure include the first set of multiple films and the second set of multiple films. In the first set of multiple films, the first material layers (for example, silicon oxide (SiO₂)) and the second material layers (for example, germanium hydroxide) are arranged in an alternating manner. In the second set of multiple films, the third material layers (for example, germanium hydroxide) and the fourth material layers (for example, silicon oxide (SiO₂)) are arranged in an alternating manner. Specifically, the thickness of the fourth material layer in the second set of multiple films is greater than that of the first material layer in the first set of multiple films. In the present invention, the first set of multiple films and the second set of multiple films are designed for a long-pass filter and a low-pass filter respectively, which are combined to a narrow-band pass filter (NBPF). The narrow-band pass filter (NBPF) formed by the multiple films can be widely applied in, for example, visible (VIS) light, near-infrared (NIR) light and far-infrared (FIR) light.

Although some embodiments of the present invention and their advantages have been described in detail, it should be understood that various changes, substitutions and alterations can be made herein without departing from the spirit and scope of the invention as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and operations described in the specification. As one of ordinary skill in the art will readily appreciate from the disclosure of the present disclosure, processes, machines, manufacture, compositions of matter, means, methods, or operations, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or operations.

What is claimed is:

1. An optical structure, comprising:
a substrate; and
multiple films disposed on the substrate, wherein the multiple films comprise:
a first set of multiple films comprising a plurality of first material layers with a first refractive index and a plurality of second material layers comprising germanium oxide, germanium nitride or germanium hydroxide with a second refractive index, wherein the first material layers and the second material layers are arranged in an alternating manner, and the second refractive index is greater than the first refractive index; and
a second set of multiple films disposed on the first set of multiple films, the second set of multiple films comprising a plurality of third material layers comprising germanium oxide, germanium nitride or germanium hydroxide with a third refractive index and a plurality of fourth material layers with a fourth refractive index, wherein the third material layers and the fourth material layers are arranged in an alternating manner, and the third refractive-index is greater than the fourth refractive index,
wherein the fourth material layer has a thickness which is greater than that of the first material layer.

2. The optical structure as claimed in claim 1, further comprising a fifth material layer with a fifth refractive index disposed between the first set of multiple films and the second set of multiple films, wherein the fifth refractive index is less than the second refractive index and the third refractive index.

3. The optical structure as claimed in claim 2, wherein the first refractive index, the fourth refractive index and the fifth refractive index are in a range from 1.47 to 1.60 at a spectral range of 200 nm to 2200 nm.

4. The optical structure as claimed in claim 1, wherein the first material layer, the fourth material layer and the fifth material layer comprise silicon oxide (SiO₂), titanium oxide (TiO₂), niobium oxide (Nb₂O₅), tantalum oxide (Ta₂O₅), aluminum oxide (Al₂O₃) or silicon nitride (SiN).

5. The optical structure as claimed in claim 1, wherein the second refractive index and the third refractive index are in a range from 3.98 to 4.42 at a spectral range of 200 nm to 2200 nm.

6. The optical structure as claimed in claim 1, wherein the first material layer has a thickness which is 1-2 times λ/4, and λ is a wavelength of an incident light.

7. The optical structure as claimed in claim 1, wherein the second material layer has a thickness which is 0.2-0.5 times λ/4, and λ is a wavelength of an incident light.

8. The optical structure as claimed in claim 7, wherein the third material layer has a thickness which is 0.2-0.5 times λ/4, and λ is the wavelength of the incident light.

9. The optical structure as claimed in claim 8, wherein the thickness of the second material layer is the same as that of the third material layer.

10. The optical structure as claimed in claim 1, wherein the fourth material layer has a thickness which is 2-3 times λ/4, and λ is a wavelength of an incident light.

11. The optical structure as claimed in claim 2, wherein the fifth material layer has a thickness of λ/4, and λ is a wavelength of an incident light.

12. The optical structure as claimed in claim 1, wherein in the first set of multiple films, there are 2 to 5 the first material layers alternating with 2 to 5 the second material layers.

13. The optical structure as claimed in claim 1, wherein in the second set of multiple films, there are 2 to 5 the third material layers alternating with 2 to 5 the fourth material layers.

14. The optical structure as claimed in claim 2, wherein the multiple films are arranged in an (xL₁ y₁H₁)ₘ L₃ (y₂H₂ zL₂)ₙ order, wherein,
in (xL₁ y₁H₁)ₘ representing the first set of multiple films, L₁ represents the first material layer, H₁ represents the second material layer, x represents the thickness of the first material layer, y₁ represents the thickness of the second material layer, and m is a quantity of alternating the first material layer and the second material layer, wherein x is 1-2 times λ/4, y₁ is 0.2-0.5 times λ/4, and m is an integer between 2 and 5,
in (y₂H₂ zL₂)ₙ representing the second set of multiple films, H₂ represents the third material layer, L₂ represents the fourth material layer, y₂ represents the thickness of the third material layer, z represents the thickness of the fourth material layer, and n is a quantity of alternating the third material layer and the fourth material layer, wherein y₂ is 0.2-0.5 times λ/4, z is 2-3 times λ/4, n is an integer between 2 and 5, and λ is a wavelength of an incident light, and
L₃ represents the fifth material layer.

15. The optical structure as claimed in claim 2, wherein the multiple films are arranged in an (1.15L₁ 0.25H₁)ₘ L₃ (0.25H₂ 2.2L₂) n order, wherein,
in (1.15L₁ 0.25H₁)ₘ representing the first set of multiple films, L₁ represents the first material layer, H₁ represents the second material layer, 1.15 represents the thickness of the first material layer and is 1.15 times λ/4, 0.25 represents the thickness of the second material layer and is 0.25 times λ/4, and m is a quantity of alternating the first material layer and the second material layer, wherein m is an integer between 2 and 5,
in (0.25H₂ 2.2L₂)ₙ representing the second set of multiple films, H₂ represents the third material layer, L₂ represents the fourth material layer, 0.25 represents the thickness of the third material layer and is 0.25 times λ4, 2.2 represents the thickness of the fourth material layer and is 2.2 times λ/4, and n is a quantity of alternating the third material layer and the fourth material layer, wherein n is an integer between 2 and 5, and λ is a wavelength of an incident light, and
L₃ represents the fifth material layer.

16. The optical structure as claimed in claim 1, wherein the multiple films further comprise a sixth material layer with a sixth refractive index which is in a range from 1.20 to 4.46 or from 2.00 to 2.67 at a spectral range of 200 nm to 2200 nm.

17. The optical structure as claimed in claim 16, wherein the multiple films further comprise a seventh material layer with a seventh refractive index which is in a 2 range from 1.47 to 1.51 or from 2.24 to 2.77 at a spectral range of 200 nm to 2200 nm.

18. The optical structure as claimed in claim 1, wherein the multiple films have a total thickness which is in a range from 4 μm to 5 μm.

19. The optical structure as claimed in claim 1, wherein the multiple films have a total number of layers which is in a range from 17 to 25.

20. The optical structure as claimed in claim 1, wherein the multiple films comprise a narrow-band pass filter that allows visible light, near-infrared light or far-infrared light to pass through.
